(19) United States
(12) Patent Application Publication
(10) Pub. No.: US 2023/0350525 A1
(43) Pub. Date: Nov. 2, 2023

(54) Touch Panel, Touch Device, and Touch Display Device

(71) Applicant: WUXI MESH TECH CO., LTD., Wuxi (CN)

(72) Inventors: Shengzhi ZHUANG, Wuxi (CN); Yufang XUE, Wuxi (CN); Minghong ZHU, Wuxi (CN); Jinhong FANG, Wuxi (CN); Mengdan XIN, Wuxi (CN); Chenming YANG, Wuxi (CN); Chenya HONG, Wuxi (CN); Ying HUANG, Wuxi (CN)

(73) Assignee: WUXI MESH TECH CO., LTD., Wuxi (CN)

(21) Appl. No.: 18/348,482

(22) Filed: Jul. 7, 2023

Related U.S. Application Data
(63) Continuation of application No. PCT/CN2021/111246, filed on Aug. 6, 2021.

(30) Foreign Application Priority Data
Jan. 7, 2021 (CN) 202110019122.5
Jan. 7, 2021 (CN) 202110020137.3
Jan. 7, 2021 (CN) 202110020142.4
Jan. 7, 2021 (CN) 202120041909.7
Jan. 7, 2021 (CN) 202120041910.X
Jan. 7, 2021 (CN) 202120042039.5

(51) Int. Cl. G06F 3/044; G06F 3/041

(52) U.S. Cl. CPC G06F 3/0445; G06F 3/0446; G06F 3/0412; G06F 3/04164; G06F 3/0448; G06F 2203/04106; G06F 2203/04112

(57) ABSTRACT

Disclosed are a touch panel, a touch device, and a touch display device. The touch panel has a touch area, and the touch panel includes at least two first type electrode layers which are stacked, the first type electrode layer having a first type touch sensing area, and respective first type touch sensing areas of the at least two first type electrode layers being spliced and filled in the touch area. In the embodiments of the present disclosure, one type of electrode layer is arranged as a multilayer structure, so that an identification degree of a touch signal is improved.

### CROSS-REFERENCE TO RELATED APPLICATIONS

The present application is a continuation application of International Application No. PCT/CN2021/111246, filed on Aug. 6, 2021, which claims priority to Chinese Patent Application No. 202110020142.4, filed on Jan. 7, 2021, Chinese Patent Application No. 202120042039.5, filed on Jan. 7, 2021, Chinese Patent Application No. 202110019122.5, filed on Jan. 7, 2021, Chinese Patent Application No. 202120041910.X, filed on Jan. 7, 2021, Chinese Patent Application No. 202110020137.3, filed on Jan. 7, 2021, and Chinese Patent Application No. 202120041909.7, filed on Jan. 7, 2021. The above applications are incorporated herein by reference in their entireties.

### TECHNICAL FIELD

The present disclosure relates to the field of touch technologies, in particular, to a touch panel, a touch device, and a touch display device.

### BACKGROUND

Nowadays, electronic products are indispensable product in daily life of people, especially the electronic products with a touch function. With the increase of touch requirements of people for the electronic products, the touch requirements for touch products are also higher and higher.

However, in an existing touch panel technologies, due to a limitation of a structure of the touch panel, the touch sensitivity or accuracy may not meet the use requirement in an actual operation process, an identification degree of a signal is poor, and a use experience of the user is reduced.

### SUMMARY

Objectives of the present disclosure are to provide a touch panel, a touch device, and a touch display device, which can enhance an identification degree of a touch signal in view of the deficiencies in the prior art.

In a first aspect, the present disclosure provides a touch panel, the touch panel has a touch area, and the touch panel includes: at least two first type electrode layers which are stacked, the first type electrode layers having a first type touch sensing area, and respective first type touch sensing areas of the at least two first type electrode layers are spliced and filled in the touch area.

In an embodiment of the present disclosure, the first type touch sensing area includes a plurality of first type electrodes extending along a first direction; the first type electrode layer further includes a first peripheral circuit region adjacent to the touch area, where the first peripheral circuit region includes a plurality of first signal leads, first ends of which are electrically connected to the plurality of first type electrodes, and the plurality of first signal leads are distributed on at least one side of the first peripheral circuit region.

In an embodiment of the present disclosure, the plurality of first signal leads are distributed on a first side, adjacent to the first type touch sensing area, of the first peripheral circuit region, and the first side is provided with a lead concentration portion, and second ends of the plurality of first signal leads are converged into at least one lead concentration portion.

In an embodiment of the present disclosure, the plurality of first signal leads are distributed on a first side and a second side, adjacent to the first type touch sensing area, of the first peripheral circuit region, the first side and the second side are both provided with a lead concentration portion, and second ends of the plurality of first signal leads are converged into the lead concentration portion.

In an embodiment of the present disclosure, the plurality of first type electrodes are metal mesh electrodes which are patterned, and respective first type electrodes of the at least two first type electrode layers are different in polygonal metal mesh patterns.

In an embodiment of the present disclosure, the touch panel further includes at least one first optical adhesive layer for adhering the at least two first type electrode layers, where the at least two first type electrode layers are adhered by the at least one first optical adhesive layer.

In an embodiment of the present disclosure, the touch panel further includes at least one first substrate for carrying the at least two first type electrode layers, where the at least two first type electrode layers are respectively arranged on different surfaces of the at least one first substrate.

In an embodiment of the present disclosure, the touch panel further includes at least one second type electrode layer, where the second type electrode layer includes a second type touch sensing area, where when a quantity of the second type electrode layers is greater than or equal to two layers, the at least one second type electrode layer includes at least two second type electrode layers which are stacked, and respective second type touch sensing area of the at least two second type electrode layers are spliced and filled in the touch area.

In an embodiment of the present disclosure, the second type touch sensing area includes a plurality of second type electrodes extending along a second direction, the plurality of second type electrodes are metal mesh electrodes which are patterned, and respective second type electrodes of the at least two second type electrode layers are different in polygonal metal mesh patterns.

In an embodiment of the present disclosure, the second type electrode layer further includes a second peripheral circuit region adjacent to the touch area, where the second peripheral circuit region includes a plurality of second signal leads, first ends of which are electrically connected to the plurality of second type electrodes, and the plurality of second signal leads are distributed on at least one side of the second peripheral circuit region.

In an embodiment of the present disclosure, the plurality of second signal leads are distributed on a fourth side, adjacent to the second type touch sensing area, of the second peripheral circuit region, the fourth side is provided with a lead concentration portion, and second ends of the plurality of second signal leads are converged into at least one lead concentration portion.

In an embodiment of the present disclosure, the plurality of second signal leads are distributed on a first side and a fourth side, adjacent to the second type touch sensing area, of the second peripheral circuit region, the first side and the fourth side are both provided with a lead concentration portion, and second ends of the plurality of second signal leads are converged into the lead concentration portion.

In an embodiment of the present disclosure, the touch panel further includes at least one second optical adhesive layer for adhering the at least two second type electrode layers, where the at least two second type electrode layers are adhered by the at least one second optical adhesive layer.

In an embodiment of the present disclosure, the touch panel further includes at least one second substrate for carrying the at least two second type electrode layers, where the at least two second type electrode layers are respectively arranged on different surfaces of the at least one second substrate.

In a second aspect, the embodiment of the present disclosure provides a touch display device, including a display screen, and a touch panel according to the first aspect.

In the third aspect, the embodiment of the present disclosure provides a touch device, including: the touch panel according to the first aspect, where at least two first type electrode layers and the at least one second type electrode layer are respectively formed mutual capacitance structures; and a signal conditioning chip connected to the touch panel and used for receiving an inductive capacitance value output by the touch panel, and determining a validity of the inductive capacitance value based on a set capacitance threshold corresponding to respective mutual capacitance structures.

In an embodiment of the present disclosure, the set capacitance threshold is related to an electrode spacing between a corresponding mutual capacitance structures, and/or the set capacitance threshold is related to a distance from a corresponding upper layer electrode layer forming the mutual capacitance structure to a surface of the touch device.

In an embodiment of the present disclosure, a quantity of the set capacitance thresholds is 4, the set capacitance thresholds include a first set capacitance threshold, a second set capacitance threshold, a third set capacitance threshold and a fourth set capacitance threshold, the at least two first type electrode layers include a first electrode layer and a second electrode layer, the at least one second type electrode layer includes a third electrode layer and a fourth electrode layer, the first electrode layer, the third electrode layer, the second electrode layer, and the fourth electrode layer are sequentially stacked, and a first mutual capacitance structure composed of the first electrode layer and the third electrode layer corresponds to the first set capacitance threshold; a second mutual capacitance structure composed of the second electrode layer and the third electrode layer corresponds to the second set capacitance threshold; a third mutual capacitance structure composed of the second electrode layer and the fourth electrode layer corresponds to the third set capacitance threshold; a fourth mutual capacitance structure composed of the first electrode layer and the fourth electrode layer corresponds to the fourth set capacitance threshold.

In an embodiment of the present disclosure, a quantity of the set capacitance thresholds is 2, the set capacitance thresholds include a fifth set capacitance threshold and a sixth set capacitance threshold, the at least two first type electrode layers include a fifth electrode layer and a sixth electrode layer, the at least one second type electrode layer includes a seventh electrode layer, the fifth electrode layer, the seventh electrode layer, and the sixth electrode layer are sequentially stacked, and a fifth mutual capacitance structure composed of the fifth electrode layer and the seventh electrode layer corresponds to the fifth set capacitance threshold; a sixth mutual capacitance structure composed of the seventh electrode layer and the sixth electrode layer corresponds to the sixth set capacitance threshold.

In an embodiment of the present disclosure, the signal conditioning chip is an independent chip, which is respectively connected to the touch panel and a touch chip of the touch device; or the signal conditioning chip is integrated in a flexible circuit board, and the flexible circuit board is configured to connect the touch panel and the touch chip; or the signal conditioning chip is integrated in the touch chip.

The embodiment of the present disclosure provides a touch panel, a touch device and a touch display device, one type of the electrode of touch electrodes is arranged in different layers, so that distances between the touch capacitor units and fingers at different positions in the touch area are not exactly the same, and distances between two electrodes constituting the capacitor unit are not exactly the same, so that the induction signal is not exactly the same when the finger touches at the different positions, thereby helping to identity a touch position and improving an identification degree of a touch signal.

### BRIEF DESCRIPTION OF THE DRAWINGS

In order to more clearly illustrate the embodiments of the present disclosure or the ordinary skill in the prior art, the following briefly introduces the accompanying drawings used in describing the embodiments. Obviously, the introduced accompanying drawings are only a part of the accompanying drawings to be described in the disclosure. For those of ordinary skill in the art, other accompanying drawings may be obtained based on these accompanying drawings without paying creative work.

FIG. 1 is a schematic structural diagram of a top view of a touch panel according to an embodiment of the present disclosure.

FIG. 2 is a schematic structural diagram of a top view of a touch panel according to another embodiment of the present disclosure.

FIG. 3 is a schematic structural diagram of a metal mesh electrode which is patterned according to an embodiment of the present disclosure.

FIG. 4 is a schematic structural diagram of a metal mesh electrode which is patterned according to another embodiment of the present disclosure.

FIG. 5 is a schematic structural diagram of a metal mesh electrode which is patterned according to yet another embodiment of the present disclosure.

FIG. 6 is a schematic structural diagram of a top view of a touch panel according to yet another embodiment of the present disclosure.

FIG. 7 is a schematic structural diagram of a front view of at least two first type electrode layers according to an embodiment of the present disclosure.

FIG. 8 is a schematic structural diagram of a top view of a touch panel according to yet another embodiment of the present disclosure.

FIG. 9 is a schematic structural diagram of a top view of a touch panel according to yet another embodiment of the present disclosure.

FIG. 10 is a schematic structural diagram of a top view of a touch panel according to yet another embodiment of the present disclosure.

FIG. 11 is a schematic structural diagram of a top view of an electrode arrangement of a touch panel according to an embodiment of the present disclosure.

FIG. 12 is a schematic structural diagram of a three-dimensional structure of a touch panel according to an embodiment of the present disclosure.

FIG. 13 is a schematic structural diagram of a three-dimensional structure of a touch panel according to another embodiment of the present disclosure.

FIG. 14 is a schematic structural diagram of a top view of a touch panel according to yet another embodiment of the present disclosure.

FIG. 15 is a schematic structural diagram of a top view of a touch device according to an embodiment of the present disclosure.

FIG. 16 is a schematic structural diagram of a signal conditioning chip of a touch device according to an embodiment of the present disclosure.

FIG. 17 is a schematic structural diagram of a signal conditioning chip of a touch device according to another embodiment of the present disclosure.

FIG. 18 is a schematic structural diagram of a top view of a touch device according to another embodiment of the present disclosure.

FIG. 19 is a schematic structural diagram of a front view of a touch display device according to yet another embodiment of the present disclosure.

### DETAILED DESCRIPTIONS OF THE EMBODIMENTS

In order to make the purpose, technical scheme and advantages of the present disclosure more clearly, the following will fully describe the technical solutions of the present disclosure through specific implementations with reference to the accompanying drawings in the embodiment of the present disclosure. Obviously, the described embodiments are a part of the embodiments of this present disclosure, rather than all the embodiments. Based on the embodiment of this present disclosure, all other embodiments obtained by those of ordinary skill in the art without creative work fall within the protection scope of the present disclosure.

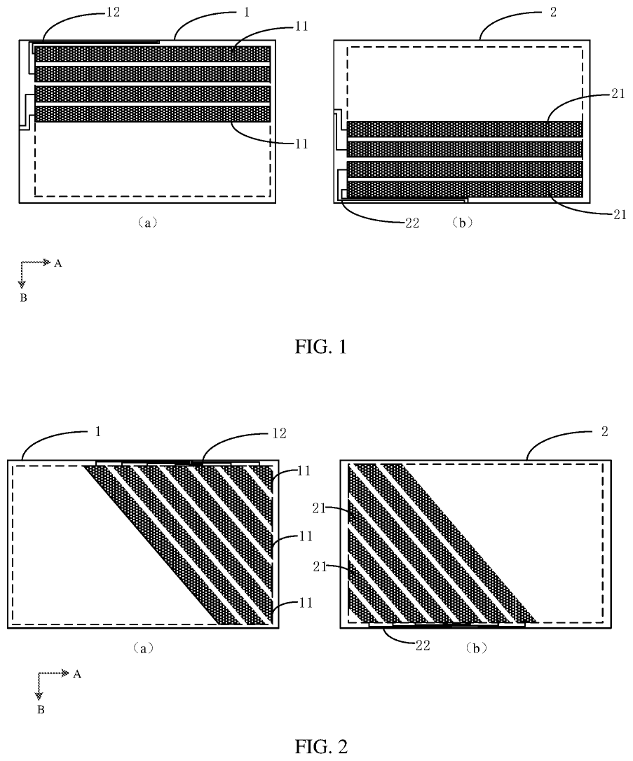

FIG. 1 is a schematic structural diagram of a top view of a touch panel according to an embodiment of the present disclosure. As shown in FIG. 1, the touch panel provided by the embodiments of the present disclosure includes a touch area, and two layers of the first type electrode layers which are stacked, such as one first type electrode layer 1 (i.e., the first type electrode layer 1 in (a) of FIG. 1) and another first type electrode layer 2 (i.e., the first type electrode layer 2 in (b) of FIG. 1) in FIG. 1. Respective first type electrode layers 1 (or 2) includes a first type touch sensing area. The respective first type touch sensing area of the two layers of the first type electrode layers (i.e., the first type electrode layer 1 in (a) of FIG. 1 and the first type electrode layer 2 in (b) of FIG. 1) are spliced and filled in the touch area of the touch panel.

Specifically, the top view direction shown in FIG. 1 is a direction perpendicular to the touch panel from top to bottom, the quantity of the stacked first type electrode layers is not limited to the two layers mentioned in the embodiments of the present disclosure, and may also be three, four or more layers, which is not specifically limited in the embodiments of the present disclosure.

With continued reference to FIG. 1, the two layers of the first type electrode layers which are stacked may be stacked on the first type electrode layers 2 in (b) of FIG. 1 and the first type electrode layer 1 in (a) of FIG. 1. In the first type electrode layer 1, the first type touch sensing area is the touch area formed by combining a plurality of first type electrodes 11 extending along a first direction A, and any two adjacent first type electrodes 11 are not connected to each other. In the first type electrode layer 2, the first type touch sensing area is the touch area formed by combining a plurality of first type electrodes 21 extending along the first direction A, and any two adjacent first type electrodes 21 are not connected to each other. After the first type electrode layers 1 and 2 are stacked, the first type touch sensing area formed by combining a plurality of first type electrodes 11 and the first type touch sensing area formed by combining a plurality of first type electrodes 21 are spliced and filled in the entire touch area. Alternatively, the plurality of first type electrodes 11 and the plurality of first type electrodes 21 do not overlap and are exactly filled to the entire touch area.

The touch area may be a central area of the touch panel, which is equivalent to a display area of a touch screen. The touch area may also be understood as an area formed by combining a plurality of the first type touch sensing areas.

The first type touch sensing area may include a plurality of first type electrodes (such as the first type electrode 11 or the first type electrode 21 shown in FIG. 1) parallel to the first direction A. The first type touch sensing area may also include a plurality of first type electrodes (such as the first type electrode 11 or the first type electrode 21 shown in FIG. 2) with a certain angle to the first direction A. Moreover, the sizes of the first type touch sensing areas included in the respective two layers of the first type electrode layers may be equal (i.e., the touch areas are equally divided, as shown in FIG. 1), or may not be the same. In addition, a shape of the first type touch sensing area may be a rectangular (such as FIG. 1), a trapezoidal (such as FIG. 2), a triangle or other polygons. The size, shape and composition of the first type touch sensing area are not specifically limited in the embodiments of the present disclosure.

In an example, the first type electrode layer may be any one of a driving electrode layer or an induction electrode layer. For example, the first type electrode layer is a driving electrode layer, and the first type electrode layer is a driving electrode, or the first type electrode layer is an induction electrode layer, and the first type electrode layer is an induction electrode.

It should be noted that the touch panel provided by the embodiments of the present disclosure further includes a plurality of first signal leads 12 (or 22), and the plurality of first type electrodes 11 are electrically connected to the plurality of first signal leads 12, respectively. A one layer of the first type electrode 11 is electrically connected to a one layer of the first signal lead 12 (or a one layer of the first type electrode 21 is electrically connected to a one layer of the first signal lead 22), so that the plurality of first signal leads 12 are converged into a certain area of at least one side surface of the touch panel (which may be an top side, a bottom side, a left side or a right side of the touch panel) to be connected to a touch chip, thereby connecting the first type electrode 11 with the touch chip.

The plurality of first signal leads 12 (or 22) may be a plurality of metal leads. A width of the plurality of first signal leads 12 (or 22) is 4 μm to 15 μm, and the material may be silver, copper or nanoscale conductive powder (the powder particles are 10 nm to 100 nm). The preparation process of the plurality of first signal leads 12 may be any one of screen printing, laser etching, 3D printing, and the like.

It should be understood that the quantity of the first type electrode layer shown in FIG. 1, and FIG. 2 also includes two layers of the first type electrode layers, that is, the first type electrode layer 1 in (a) of FIG. 2 and the first type electrode layer 2 in (b) of FIG. 2. The first type electrode layer 1 in (a) of FIG. 2 includes a first type touch sensing area composed of a plurality of first type electrodes 11 with a certain angle to the first direction A. The first type electrode layer 2 in (b) of FIG. 2 also includes a first type touch sensing area composed of a plurality of first type electrodes 21 with a certain angle to the first direction A, and a plurality of first signal leads 22 are electrically connected to the plurality of first type electrodes 21. Moreover, based on the first type touch sensing area formed by combining the plurality of first type electrodes 11 and the first type touch sensing area formed by combining the plurality of first type electrodes 21, the entire touch area may be spliced and filled.

Therefore, compared with the prior art, the mutual capacitive touch sensor is composed of a layer of driving electrodes and a layer of sensing electrodes, that is, the electrodes of the same type (the electrodes extending in the same direction) are all arranged in the same electrode layer (such as the driving electrodes are all arranged in one driving electrode layer), so that the difference between the capacitance values at different positions in the touch area is not large, and the identification degree is not high when the touch position is identified. In the embodiments of the present disclosure, by arranging one type of electrode of touch electrodes in different layers, the distances between the touch capacitor unit and a finger at different positions in the touch area are not exactly the same, and the distances between the two electrodes constituting the capacitor unit are not exactly the same, so that the induction signal is not exactly the same when the finger touches the different positions, thereby helping to identify the touch position and improving an identification degree of a touch signal.

In an embodiments of the present disclosure, the first type touch sensing area includes a plurality of first type electrodes extending along the first direction, the plurality of first type electrodes are metal mesh electrodes which are patterned, and respective first type electrodes of the at least two first type electrode layers are different in polygonal metal mesh patterns.

Specifically, as shown in FIG. 1, the first direction A and the second direction B are perpendicular to each other, and the first direction A or the second direction B may be an X-axis direction (transverse) or a Y-axis direction (longitudinal) of a two-dimensional rectangular coordinate system. That is, when the first direction A refers to the X-axis direction (transverse), then the second direction B refers to the Y-axis direction (longitudinal); When the first direction A refers to the Y-axis direction (longitudinal), then the second direction B refers to the X-axis direction (transverse).

The first type touch sensing area includes a plurality of first type electrodes extending along the first direction A, that is, the first type touch sensing area may include a plurality of first type electrodes extending transversely. In an embodiment, the first type touch sensing area may also include a plurality of first type electrodes (such as the first type electrodes 11 or the first type electrodes 21 shown in FIG. 2) extending at a certain angle to the first direction A. The actual contour structure of the first type electrode may be a strip, a diamond or a triangle, and those skilled in the art may design a specific contour structure according to actual application requirements. Meanwhile, the embodiments of the present disclosure also do not limit an actual internal pattern of the first type electrode, and the internal pattern may be various types of meshes, and the those skilled in the art may design the internal pattern of the first type electrode according to the actual application requirements.

A material of the metal mesh electrodes may be at least one of Cu, Ag, Al, Ti or Ni. The mesh pattern of the metal mesh layers may be a rectangular, a square, a diamond or other polygons, and the metal mesh electrode and the mesh pattern are not specifically limited in the embodiments. In addition, it should be noted that although metal wires in the metal mesh are opaque to light, since the metal wires is thin, the human eyes cannot feel the metal wires, that is, the metal mesh is transparent in human vision and is not affect a transparency of the touch panel.

In one embodiment, respective first type electrodes of the at least two first type electrode layers are different in polygonal metal mesh patterns.

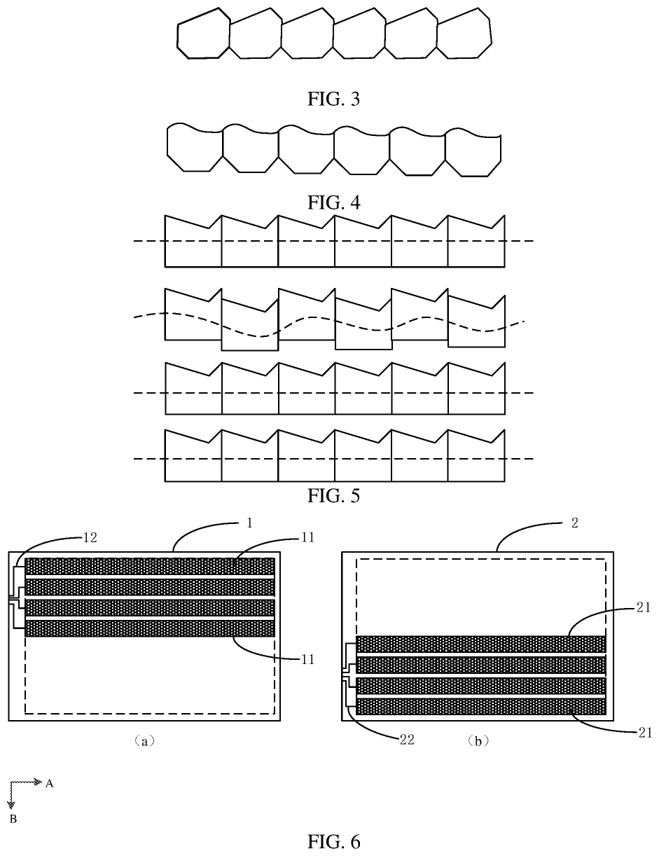

The polygonal metal mesh pattern may be an irregular polygonal metal mesh pattern. The irregular polygon may be a non-regular polygon, that is, a length of at least one edge in the polygon is not equal to the length of the other edges, for example, FIG. 3; or at least one edge of the polygonal may be a curve or a fold line, for example, FIG. 4; or the included angle in the polygonal is different , for example, the angle of the included angle formed by any two adjacent edges in each polygon is configured in a random manner within an appropriate angle range, and the appropriate angle range may be set to be 75 and 125 degrees; or the metal wires in the metal mesh electrode which is patterned are at least partially non-linear, for example, FIG. 5 (the dotted line in the FIG. 5 represents the arrangement mode of the metal wires), and the present disclosure is not specifically limit the irregular polygon pattern.

The non-identical polygonal metal mesh pattern referred to herein may refer to at least one of different included angles of polygons, different side lengths and different bending degrees of edges. That is to say, as long as the patterns between the first type electrode layers of each layer are different from each other. Even if the layers are irregular polygonal metal mesh patterns, and the patterns between the layers are also different. For example, the two layers of the first type electrode layers are included, where an edge length of the polygonal metal mesh pattern of one layer of the first type electrode layer and an edge length of the polygonal metal mesh pattern of the other first type electrode layer are different. For another example, the two layers of the first type electrode layers are included, where an edge bending degree of the polygonal metal mesh pattern of one layer of the first type electrode layer and an edge bending degree of the polygonal metal mesh pattern of the other first type electrode layer are different.

Therefore, in the embodiments of the present disclosure, the at least two first type electrode layers are arranged to be patterned metal mesh electrodes by using thinner metal wires, so that the light transmittance of the touch panel is increased. Meanwhile, the at least two first type electrode layers are arranged to be different patterned metal mesh electrodes, so that on one hand, interference fringes may be avoided, and on the other hand, due to different electrode resistance values formed by different metal mesh patterns, the capacitance values of different areas may be different, and an identifiable feature of the induction signal may be further increased.

In an embodiment of the present disclosure, the first type electrode layer further includes a first peripheral circuit region adjacent to the touch area, where the first peripheral circuit region includes a plurality of first signal leads, first ends electrically connected to the plurality of first type electrodes, and the plurality of first signal leads are distributed on at least one side of the first peripheral circuit region.

Specifically, as shown in FIG. 1, the first type electrode layer 1 further includes the first peripheral circuit region adjacent to the touch area (i.e., the part between the frame of the first type electrode layer 1 and the dashed frame in (a) of FIG. 1), where the first peripheral circuit region includes a plurality of first signal leads 12 (or 22), first end electrically connected to the plurality of first type electrodes 11 (or 21). The plurality of first signal leads 12 (or 22) are distributed on the at least one side of the first peripheral circuit region.

The first peripheral circuit region may also be the part between the frame of the first type electrode layer 2 and the dashed frame in (b) of FIG. 1. The first peripheral circuit region further includes the plurality of first signal leads 12 (or 22), and the plurality of first type electrodes 11 are electrically connected to the plurality of first signal leads 12 respectively. A one layer of the first type electrode 11 is electrically connected to a one layer of the first signal lead 12 (or a one layer of the first type electrode 21 is electrically connected to a one layer of the first signal lead 22), so that the plurality of first signal leads 12 are converged into a certain area of at least one side surface of the first peripheral circuit region (which may be the top side, the bottom side, the left side, or the right side of the touch panel) to be connected to the touch chip, thereby connecting the first type electrode 11 with the touch chip.

In an embodiment, as shown in FIG. 1, the plurality of first signal leads 12 are distributed on a first side and a second side, adjacent to the first type touch sensing area, of the first peripheral circuit region, the first side and the second side are both provided with a lead concentration portion, and second ends of the plurality of first signal leads converge into the lead concentration portion.

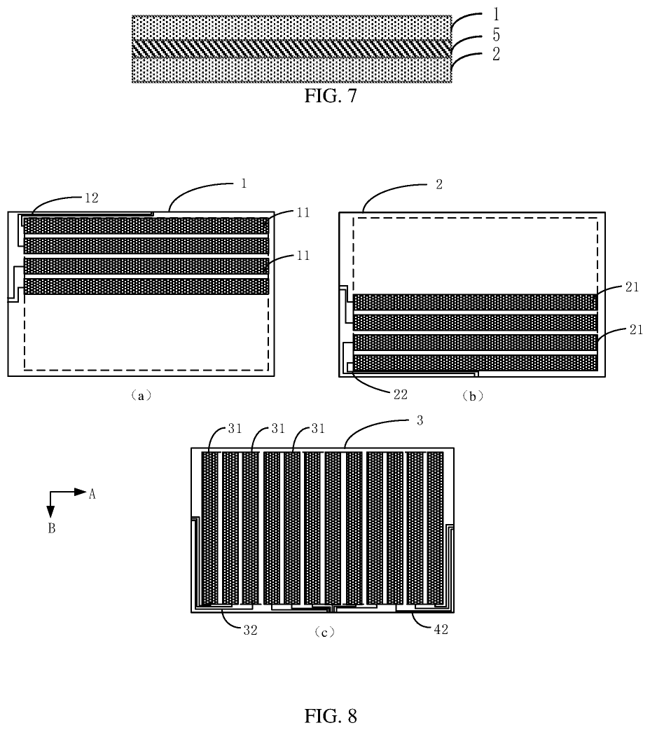

In an embodiment, as shown in FIG. 6, the plurality of first signal leads are distributed on a first side, adjacent to the first type touch sensing area, of the first peripheral circuit region, and the first side is provided with a lead concentration portion, and second ends of the plurality of first signal leads converge into at least one lead concentration portion.

It should be noted that the plurality of first signal leads are distributed on a third side or a fourth side of the first peripheral circuit region, which is not specifically limited in the embodiments of the present disclosure. Please refer to the description of the following embodiments for details of the arrangement of the first signal leads to avoid repetition here.

Therefore, in the embodiments of the present disclosure, one type of electrode is arranged in different layers, so that the quantity of the signal leads corresponding to each layer of electrodes is reduced, thereby reducing a width of the peripheral circuit region, and further reducing an edge width of the touch panel.

In an embodiment of the present disclosure, the plurality of first signal leads are distributed on a first side, adjacent to the first type touch sensing area, of the first peripheral circuit region, and the first side is provided with a lead concentration portion, and second ends of the plurality of first signal leads converge into at least one lead concentration portion.

Specifically, as shown in FIG. 6, the first type electrode layer 1 (or 2) includes a first side (such as the first side may be the left side of the orientation shown in FIG. 6), a second side (such as the second side may be the upper side of the orientation shown in FIG. 6), a third side (such as the third side may be the right side of the orientation shown in FIG. 6) and a fourth side (such as the fourth side may be the lower side of the orientation shown in FIG. 6) which are adjacent in sequence, where the first side is opposite to the third side, and the second side is opposite to the fourth side. The first type touch sensing area includes a plurality of first type electrodes 11 (or 21) extending from the first side to the third side (i.e., the first direction A).

With continued reference to FIG. 6, the respective two layers of the first type electrode layer which are stacked includes the first peripheral circuit region (i.e., the part between the frame of the first type electrode layer 1 (or 2) and the dashed frame in (a) of FIG. 6 or (b) of FIG. 6) and a first type touch sensing area. The first peripheral circuit region includes a plurality of first signal leads 12 (or 22). The plurality of first signal leads 12 (or 22) converge into the first side or the third side, near first end of the first type touch sensing area, of the first peripheral circuit region. The first side (or the third side) of the first peripheral circuit region is provided with a lead concentration portion. The lead concentration portion may be a concentrating place of the plurality of signal leads at the first side, and first ends of a plurality of first signal leads 12 are electrically connected to a plurality of first type electrodes 11 respectively, and the second ends are converged into the lead concentration portion and are connected to the touch chip. The specific distribution positions of the plurality of first signal leads are not limited in the embodiments of the present disclosure, and flexible setting may be performed according to actual situations.

There may be one lead concentration portion located in the middle of the first type touch sensing area. For example, as shown in FIG. 6, the first signal lead 12 is converged into a middle of the first side (i.e., the left side) of the first type touch sensing area. There may also be two lead concentration portions, three or four lead concentration portions, etc., and the quantity of the lead concentration portions is not specifically limited in the embodiments of the present disclosure. The plurality of lead concentration portions may be distributed on the same side and may also be distributed on a plurality of sides of the first peripheral circuit region. Each lead can be evenly distributed and converged into the at least one lead concentration portion.

For example, both of the two lead concentration portions may be arranged on the first side, and the two lead concentration portions may also be respectively arranged on the first side and the second side as shown in the first signal lead 12 in FIG. 1 (i.e., the left side and the upper side of the first type touch sensing area in (a) of FIG. 1).

For example, the outgoing lines of the signal leads of the two layers of the first type electrode layers which are stacked are single-sided concentrated outgoing lines. That is the signal leads in the two layers of the electrode layers are both located on the first side or the third side line, or may be discharged from the second side or the fourth side, which is not specific limited in the present disclosure.

Therefore, in the embodiments of the present disclosure, the first type electrodes are arranged into at least two layers, thereby reducing the quantity of the signal leads corresponding to each layer. Meanwhile, a single-sided outgoing line manner is adopted, and compared with an electrode layer which is not layered in the prior art, the edge width of the touch panel is further reduced.

In one embodiment of the present disclosure, the plurality of first signal leads are distributed on a first side and a second side, adjacent to the first type touch sensing area, of the first peripheral circuit region, the first side and the second side are both provided with a lead concentration portion, and second ends of the plurality of first signal leads are converged into the lead concentration portion. For example, the second side may be an upper side of the orientation shown in FIG. 1.

Specifically, as shown in FIG. 1, the first type electrode layer 1 (or 2) includes a first side, a second side, a third side and a fourth side which are adjacent in sequence, where the first side is opposite to the third side, and the second side is opposite to the fourth side. The plurality of first type touch sensing area includes a plurality of first type electrodes 11 (or 21) extending from the first side to the third side (i.e., the first direction A).

The respective two layers of the first type electrode layer which are stacked includes a first peripheral circuit region and the first type touch sensing area. The first type touch sensing area includes a plurality of first signal leads 12 (or 22). The plurality of first signal leads 12 (or 22) are converged into the first side and the second side, near first end of the first type touch sensing area, of the first peripheral circuit region. The first side and the second side of the first peripheral circuit region are provided with a lead concentration portion. The lead concentration portion may be a concentrating place of the plurality of first signal leads at the first side and the second side, first ends of the plurality of first signal leads are electrically connected to the plurality of first type electrodes respectively, and the second ends of the plurality of first signal leads are converged into the lead concentration portion and are connected to the touch chip.

The arrangement mode may be that the plurality of first type electrodes 11 (or 21) are divided into two groups based on the symmetry axis parallel to the direction A in the first type touch sensing area, one group of the plurality of first type electrodes 11 converges the plurality of first signal leads 12 connected with them on the lead concentration portion of the second side, and the other group of the plurality of first type electrodes 11 converge the plurality of first signal leads 12 connected with them at the lead concentration portion on the first side, for example, the distribution of the leads in (a) of FIG. 1.

Alternatively, one group of the plurality of first type electrodes 21 converge the plurality of first signal leads 22 connected with them on the lead concentration portion of the fourth side, and the other group of the plurality of first type electrodes 21 converge the plurality of first signal leads 22 connected with them on the lead concentration portion of the first side, for example, the distribution of the leads in (b) of FIG. 1. The specific form of the distribution of the leads is not limited in the embodiments of the present disclosure.

It should be noted that the above embodiments are grouped according to the symmetry axis, and the plurality of first type electrodes are grouped, but the actual division mode may be grouped according to the form of 1:2 or 1:3, which is not specifically limited in the embodiments of the present disclosure. The plurality of first type electrodes may also be divided into three groups, four groups, etc., which is not specifically limited in the embodiments of the present disclosure.

Therefore, in the embodiments of the present disclosure, the first type electrodes are arranged into at least two layers, so that the quantity of signal leads corresponding to each layer is reduced. Meanwhile, a two-sided outgoing line manner is adopted, and the edge width of the touch panel is further reduced compared with a single-sided outgoing line manner.

In an embodiment of the present disclosure, the touch panel further includes at least one first optical adhesive layer for adhering the at least two first type electrode layers, and the at least two first type electrode layers are adhered by the at least one first optical adhesive layer.

Specifically, the quantity of the first optical adhesive layers is proportional to the quantity of the first type electrode layers, and the more the quantity of the first type electrode layers, the more the first optical adhesive layers for adhering. For example, when the quantity of the first type electrode layer is two, the quantity of the first optical adhesive layer is one; and when the quantity of the first type electrode layer is three, the quantity of the first optical adhesive layer is two.

It should be understood that in the embodiments of the present disclosure, at least two first type electrode layers may be produced on different production lines at the same time, and do not affect each other, and the at least two first type electrode layers are pasted into the touch panel only by means of the optical adhesive (such as the first optical adhesive layer) in the final assembly stage.

The optical adhesive for adhering may be fully adhered by an Optically Clear Adhesive (OCA) material. The OCA is colorless and transparent, the light transmittance is above 90%, the technology is mature, the adhering effect is good, no air layer is generated, 8% reflection may be reduced, and the display effect is improved. Moreover, through the arrangement of the OCA, when the OCA is impacted by an external force, the OCA may also absorb and release a part of the external force, so as to reduce the impact of the external force on the touch panel, and improve the impact resistance of the touch panel. However, the optical adhesive in the embodiments of the present disclosure may also use an Optically Clear Resin (OCR) material, the adhering cost of the OCR is relatively low, the light transmittance after lamination is also relatively high, the disassembly is simple, the regeneration yield after disassembly is high, and the material of the optical adhesive is not specifically limited in the embodiments of the present disclosure.

Preferably, the first optical adhesive layer in the embodiments of the present disclosure adopts an OCA optical adhesive material.

Therefore, in the embodiments of the present disclosure, the at least two first type electrode layers are adhered by means of the optical adhesive, so that the light transmittance of the touch panel is enhanced, and the external force is absorbed and released by means of the optical adhesive, thereby reducing the impact of external forces on the touch panel, and improving the impact resistance of the touch panel.

In an embodiment of the present disclosure, the touch panel further includes at least one first substrate for carrying the at least two first type electrode layers, and the at least two first type electrode layers are respectively arranged on different surfaces of the at least one first substrate.

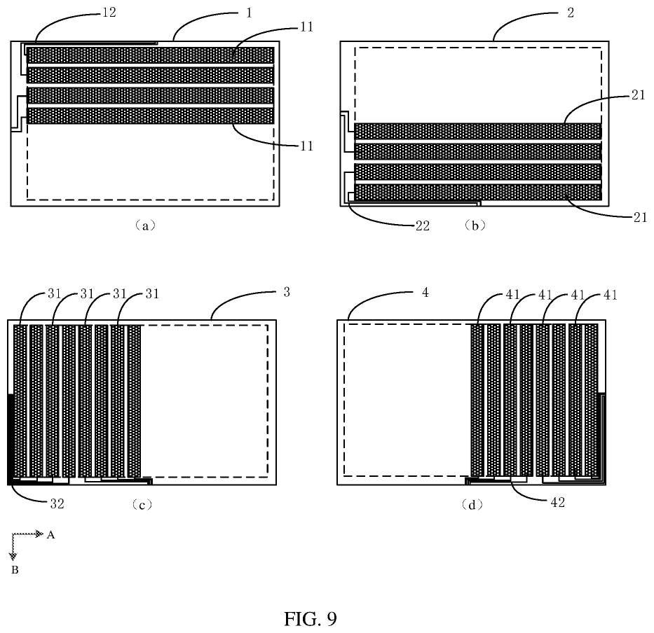

Specifically, as shown in FIG. 7, the first substrate 5 is equivalent to a carrier board to the first type electrode layer 1 and the first type electrode layer 2. The first type electrode layer 1 and the first type electrode layer 2 are respectively arranged on both sides of the first substrate 5 by yellow light process or sputtering. The quantity of the first substrate increases as the quantity of the first type electrode layer increases. For example, when the quantity of the first type electrode layer is two, the quantity of the first substrate is one; when the quantity of the first type electrode layer is three, the quantity of the first substrate is two. Forming the plurality of first type electrodes (such as refer to the first type electrodes 11 in FIG. 2) on one surface of the first substrate 5 to obtain the first type electrode layer 1, and forming the plurality of first type electrodes on the other surface of the first substrate 5 to obtain another first type electrode layer 2. In the embodiments of the present disclosure, the two layers of electrodes may be produced on different production lines at the same time, and do not affect each other.

It should be noted that the first substrate may be made of any one of the following transparent plastic material: Polyethylene terephthalate (PET), Polycarbonate (PC), Polymethyl methacrylate (PMMA), Optical material cop (COP), transparent conductive transfer film (TCTF), Triacetyl Cellulose (TAC) and other materials, which is not specifically limited in the embodiments of the present disclosure. The PET plastic has excellent physical and mechanical properties in a wide temperature range, is excellent in electrical insulation, and is still good in electrical performance and good in dimensional stability even at a temperature range and a high frequency condition.

Preferably, the material of the first substrate in the embodiments of the present disclosure is made of a PET plastic material.

Therefore, in the embodiments of the present disclosure, the two layers of the first type electrode layers are used as carriers in the correspondingly arranged substrates, so that the overall thickness of the touch panel may be reduced, and the touch panel is lighter and thinner.

FIG. 8 is a schematic structural diagram of a top view of a touch panel according to yet another embodiment of the present disclosure. The embodiment shown in FIG. 8 is an extension of the embodiment shown in FIG. 1, and the differences between the embodiment shown in FIG. 8 and the embodiment shown in FIG. 1 are described below, and details are not described herein again.

As shown in FIG. 8, the touch panel has a touch area, and the touch panel includes two layers of the first type electrode layers which are stacked, a one layer of the second type electrode layer, a plurality of first type signal leads 12 (or 22), a plurality of first type electrodes 11 (or 21), a plurality of second signal leads 32 (or 42) and a plurality of second type electrodes 31. The quantity of the first type electrode layer is two, that is, one layer of first type electrode layer 1 (i.e., the first type electrode layer 1 in (a) of FIG. 8) and the other first type electrode layer 2 (i.e., the first type electrode layer 2 in (b) of FIG. 8). The quantity of the second type electrode layer is one (i.e., the second type electrode layer 3 in (c) of FIG. 8), that is, one layer of the second type electrode layer 3.

As shown in FIG. 8, when the second type electrode layer 3 is a layer of structural design, the orthographic projection of the second type touch sensing area included in the second type electrode layer 3 in the embodiments of the present disclosure may be substantially equivalent to the touch area of the touch panel. The specific content is basically the same as that in the embodiments shown in FIG. 1. Please refer to the disclosure of the embodiments in FIG. 1, and details are not described herein again.

Therefore, the embodiments of the present disclosure, one of the two layers of the electrode layers is split, so that the signals induced by fingers to the three layers of the electrode layers are different, thereby improving an identification degree of the signal. Meanwhile, the structure of the touch panel provided by the embodiments of the present disclosure is thinner and lighter than the form of splitting the two layers of the electrode layers.

FIG. 9 is a schematic structural diagram of a top view of a touch panel according to yet another embodiment of the present disclosure. The embodiment shown in FIG. 9 is an extension of the embodiment shown in FIG. 1, and the differences between the embodiment shown in FIG. 8 and the embodiment shown in FIG. 1 are described below, and details are not described herein again.

As shown in FIG. 9, the touch panel has a touch area, and the touch panel includes two first type electrode layers and two layers of the second type electrode layers which are stacked. The quantity of first type electrode layer is two, that is, one layer of the first type electrode layer 1 and the other first type electrode layer 2; the quantity of the second type electrode layer is two, that is, one layer of the second type electrode layer 3 and the other second type electrode layer 4. The second type electrode layers 3 (or 4) each include a second type touch sensing area. The respective second type touch sensing areas of the two layers of the second type electrode layers are spliced and filled in the touch area.

Specifically, the top view direction shown in FIG. 9 is perpendicular to the direction of the touch panel from top to bottom. It should be noted that the quantity of the first type electrode layer and the second type electrode layer which are stacked is not limited to the two layers mentioned in the embodiments of the present disclosure, or may be three, four or more layers, which is not specifically limited in the embodiments of the present disclosure.

In the second type electrode layer 3, the second type touch sensing area is the touch area formed by combining the plurality of second type electrodes 31 extending along the second direction B, and any two adjacent second type electrodes 31 are not connected to each other. In the second type electrode layer 4, the second type touch sensing area is the touch area formed by combining the plurality of second type electrodes 41 extending along the second direction B, and any two adjacent second type electrodes 41 are not connected to each other. The second type touch sensing area formed by combining a plurality of second type electrodes 31 and the second type touch sensing area formed by combining a plurality of second type electrodes 41 are spliced and filled in the touch area of the touch panel.

The touch area may be a central area of the touch panel, which is equivalent to a display area of the touch screen. The touch area may also be understood as a region formed by combining a plurality of the second type touch sensing areas.

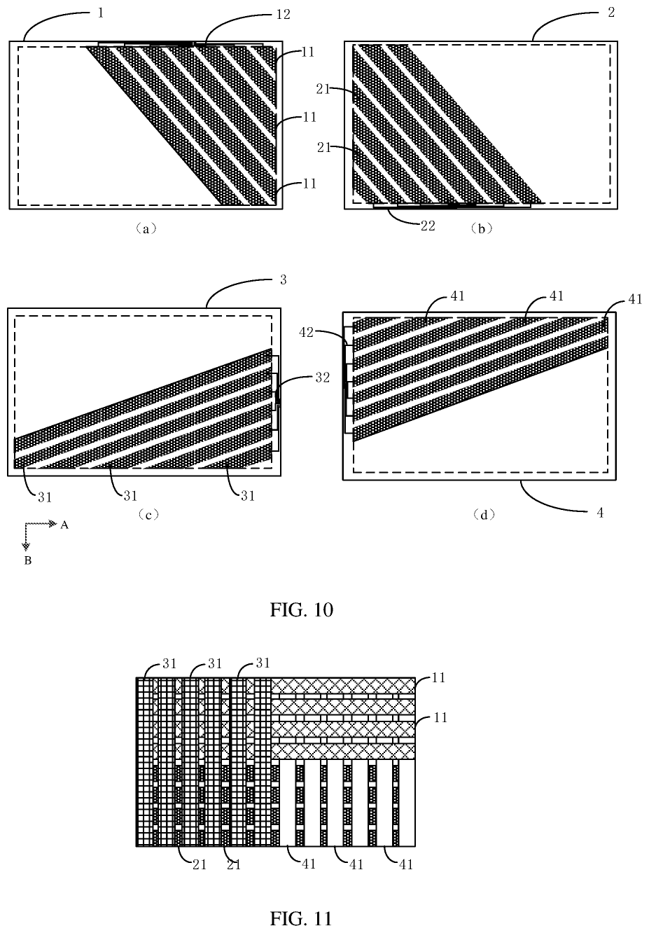

The second type touch sensing area may include a plurality of second type electrodes 31 (or 41) parallel to the second direction B. The second type touch sensing area may also include a plurality of second type electrodes (such as the second type electrode 31 or 41 shown in FIG. 10) with a certain angle to the second direction B. Moreover, respective sizes of the second type touch sensing areas of the two layers of the second type electrode layers may be equal (i.e., the touch areas are evenly divided), or may not be equal. and the shape of the second type touch sensing area may be rectangular (such as, FIG. 9), a trapezoidal (such as, FIG. 10), a triangle, or other polygons. The embodiments of the present disclosure are not specifically limit the size, shape and composition form of the second type touch sensing area.

For example, the first type electrode layer and the second type electrode layer which are stacked included in the touch panel is given below with reference to FIGS. 11 to 13.

As shown in FIG. 11, the touch area is entirely filled by the first type electrode layer and the second type electrode layer, or a plurality of first type electrodes 11 and 21, extending in the first direction, are entirely filled in the touch area without any overlap, and the plurality of second type electrodes 31 and 41, extending in the second direction, are entirely filled in the touch area without any overlap. That is, any area of the touch area corresponds to a first type electrode layer and a second type electrode layer for signal induction. Because of a height difference between the electrode layers, respective sending signals of the electrode layers are different, thereby improving an identification degree of the signals.

In one embodiment, the quantity of the first type electrode layer is two, and the quantity of the second type electrode layer is one, or the quantity of the first type electrode layer is one, and the quantity of the second type electrode layer is two.

In one embodiment, the quantity of the first type electrode layer is two, and the quantity of the second type electrode layer is two.

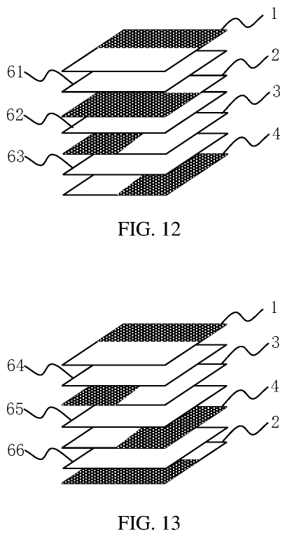

In addition, referring to each electrode layer label as shown in FIG. 9, the stacking sequence of the two layers of the first type electrode layers 1 and 2, and the two layers of the second type electrode layers 3 and 4 in the vertical direction of the touch panel shown in FIG. 11 are 3, 1, 4 and 2. It should be noted that the stacking sequence between the first type electrode layer and the second type electrode layer may be varied. With reference to the four electrode layers label 1 to 4 as shown in FIG. 9, the stacking sequence in the vertical direction of the touch panel may be 1, 2, 3 and 4, such as, FIG. 12. A one layer of the first type electrode layer 1 is adhered to the other one layer of the first type electrode layer 2 through a one layer of the first optical adhesive layer 61, and the first type electrode layer 2 is adhered to a one layer of the second type electrode layer 3 through a one layer of the second optical adhesive layer 62 (or the one layer of the first optical adhesive layer 61), and the second type electrode layer 3 is adhered to the other one layer of the second type electrode layer 4 through the other one layer of the second optical adhesive layer 63.

For another example, with reference to the four electrode layers label 1 to 4 as shown in FIG. 9, the stacking sequence in the vertical direction of the touch panel may also be 1, 3, 4 and 2, such as FIG. 13. The one layer of the first type electrode layer 1 is adhered to the one layer of the second type electrode layer 3 through the one layer of the first optical adhesive layer 64, and the second type electrode layer 3 is adhered to the other one layer of the second type electrode layer 4 through the one layer of the second optical adhesive layer 65 (or the one layer of the first optical adhesive layer 65), and the second type electrode layer 4 is adhered to the other one layer of the first type electrode layer 2 through the other one layer of the second optical adhesive layer 66.

In addition, it should be noted that the stacking sequence of the four electrode layers label 1 to 4 as shown in FIG. 9 in the vertical direction of the touch panel may also be 1, 3, 2 and 4, or 3, 2, 1 and 4, etc. The arrangement sequence of the electrode layers in the vertical direction is not specifically limited in the embodiments of the present disclosure.

In an example, the embodiments of the present disclosure, two layers of the double layer metal mesh electrodes are adhered to form the touch panel through the optical adhesive layer. It should be noted that the structure of the double layer metal mesh electrodes is not limited here, and the two layers of the double layer metal mesh electrodes are only one way of combining four electrode layers.

Such as, as shown in FIG. 9, the first type electrode layer 1 in (a) of FIG. 9 and the second type electrode layer 3 in (c) of FIG. 9 form a double layer metal mesh electrode; the first type electrode layer 2 in (b) of FIG. 9 and the second type electrode layer 4 in (d) of FIG. 9 form an another double layer metal mesh electrode, and the double layer metal mesh electrode and the another double layer metal mesh electrode are adhered by the optical adhesive layer. Alternatively, the first type electrode layer 1 in (a) of FIG. 9 and the first type electrode layer 2 in (b) of FIG. 9 form a double layer metal mesh electrode, the second type electrode layer 3 in (c) of FIG. 9 and the second type electrode layer 4 in (d) of FIG. 9 form the another double layer metal mesh electrode, and the double layer metal mesh electrode and the another double layer metal mesh electrode are adhered by the optical adhesive layer. Alternatively, the first type electrode layer 1 in (a) of FIG. 9 and the second type electrode layer 4 in (d) of FIG. 9 form a double layer metal mesh electrode, the second type electrode layer 3 in (c) of FIG. 9 and the first type electrode layer 2 in (b) of FIG. 9 form the another double layer metal mesh electrode, and the double layer metal mesh electrode and the another double layer metal mesh electrode are adhered by the optical adhesive layer.

In one example, two layers of the double layer metal mesh electrodes further include a substrate.

In one embodiment, the first type electrode layer is a driving electrode layer and the second type electrode layer is an induction electrode layer; or, the first type electrode layer is an induction electrode layer, and the second type electrode layer is a driving electrode layer.

It should be noted that, in addition to the metal mesh electrodes, the plurality of first type electrodes and the plurality of second type electrodes of the present disclosure may also be indium tin oxide electrodes (i.e., ITO electrodes). In view of the practical application, the metal mesh electrode and the ITO electrode each have excellent defects, that is, the ITO electrode has good transparency but high impedance, and the metal mesh electrode has low impedance and low light transmittance, so that the plurality of first type electrodes and the plurality of second type electrodes may be made of different materials, for example, the first type electrodes are made of the metal mesh electrodes, and the second type electrodes are made of the ITO electrodes. However, it should be noted that the embodiments of the present disclosure are not limit the specific materials of the first type electrodes and the specific materials of the second type electrodes, as long as the above mentioned shortcomings may be avoided.

As shown in FIG. 9, the touch panel further includes a second peripheral circuit region. The second peripheral circuit region is a part between the frame of the second type electrode layer 31 (or 41) and the dashed frame in (c) of FIG. 9 (or (d) of FIG. 9). The second peripheral circuit region further includes a plurality of second signal leads 32 (or 42), and the plurality of second type electrodes 31 are electrically connected to the plurality of second signal leads 32, respectively.

In an embodiment, as shown in FIG. 9, the plurality of second signal leads 32 may be distributed on a first side (or a third side) and a fourth side (such as, FIG. 9), adjacent to the second type touch sensing area, of the second peripheral circuit region. Alternatively, the plurality of second signal leads 32 may be distributed on the fourth side, adjacent to the second type touch sensing area, of the second peripheral circuit region.

It should be noted that the plurality of second signal leads may also be distributed on the third side or the fourth side of the second peripheral circuit region, and the embodiments of the present disclosure are not specifically limit the plurality of second signal leads.

It should be further noted that the first signal lead and the second signal lead are merely for convenience of distinguishing, and may be substantially the same type of signal leads or the same type of signal leads. With regard to the related description of the signal leads, please refer to the description of the embodiments in FIG. 1 for details, which is not repeated here for avoiding repetition.

It should also be understood that the quantity of the electrode layers of the touch panel shown in FIG. 10 is same as the quantity of the electrode layers of the touch panel shown in FIG. 9, and the respective electrode layers included two layers of the first type electrode layer and two layers of the second type electrode layer which are stacked. In FIG. 10, the two layers of the first type electrode layers are the first type electrode 1 in (a) of FIG. 10 and the first type electrode 2 in (b) of FIG. 10. The two layers of the second type electrode layers are the second type electrode 3 in (c) of FIG. 10 and the second type electrode 4 in (d) of FIG. 10. The first type electrode layer 1 in (a) of FIG. 10 includes a first type touch sensing area composed of the plurality of first type electrodes 11 with a certain angle to the first direction A, and the plurality of first signal leads 12 are electrically connected to the plurality of first type electrodes 11. The first type electrode layer 2 in (b) of FIG. 10 includes a first type touch sensing area composed of the plurality of first type electrodes 21 with a certain angle to the first direction A, and the plurality of first signal leads 22 are electrically connected to the plurality of first type electrodes 21. The second type electrode layer 3 in (c) of FIG. 10 includes a second type touch sensing area composed of the plurality of second type electrodes 31 with a certain angle to the second direction B, and the plurality of second signal leads 32 are electrically connected to the plurality of second type electrodes 31. The second type electrode layer 4 in (d) of FIG. 10 includes a second type touch sensing area composed of the plurality of second type electrodes 41 with a certain angle to the second direction B, and the plurality of second signal leads 42 are electrically connected to the plurality of second type electrodes 41. The first type electrode layer 1 (or 2) and the second type electrode layer 3 (or 4) are spliced and filled in the touch area.

Therefore, the structure of the touch panel provided by the embodiments of the present disclosure can enable the signals sensed by the finger to the four layers of the electrode layers to be different, thereby improving an identification degree of the signal.

In an embodiment of the present disclosure, the second type touch sensing area includes a plurality of second type electrodes extending along a second direction, the plurality of second type electrodes are metal mesh electrodes which are patterned, and respective second type electrodes of at least two second type electrode layers are different in polygonal metal mesh patterns.

Specifically, the structure of the metal mesh of the second type electrode is basically the same as the structure of the metal mesh of the first type electrode. Please refer to the description of the above embodiments, and details are not described herein again.

Therefore, in the embodiments of the present disclosure, the at least two second type electrode layers are arranged to the metal mesh electrodes with different patterns, so that interference fringes are avoided, and an identification degree of the signal is increased.

In an embodiment of the present disclosure, the second type electrode layer further includes a second peripheral circuit region adjacent to the touch area, where the second peripheral circuit region includes a plurality of second signal leads, first ends electrically connected to the plurality of second type electrodes, and the plurality of second signal leads are distributed on at least one side of the second peripheral circuit region.

Specifically, as shown in FIG. 9, the touch panel further includes a second peripheral circuit region. The second peripheral circuit region is the part between the frame of the second type electrode layer 31 (or 41) and the dashed frame in (c) of FIG. 9 (or (d) of FIG. 9). The second peripheral circuit region further includes a plurality of second signal leads 32 (or 42), and the plurality of second type electrodes 31 are electrically connected to the plurality of second signal leads 32, respectively. One second type electrode 31 is electrically connected to one second signal lead 32 (or one second type electrode 41 is electrically connected to one second signal lead 42), so that the plurality of second signal leads 42 formed thereby converge into a certain area on at least one side (which may be the top side, the bottom side, the left side or the right side of the touch panel) of the second peripheral circuit region, for connection to the touch chip, thereby connecting the second type electrode 31 (or 41) with the touch chip.

Therefore, the embodiments of the present disclosure provide a reduction in the edge width of the entire touch panel by arranging the first type electrodes in different layers, thereby reducing the quantity of the signal leads corresponding to each layer of electrodes. Additionally, the use of at least one side for wire routing further decreases the overall edge width of the touch panel.

In an embodiment of the present disclosure, the plurality of second signal leads are distributed on a fourth side, adjacent to the second type touch sensing area, of the second peripheral circuit region, the fourth side is provided with a lead concentration portion, and second ends of the plurality of second signal leads are converged into at least one lead concentration portion.

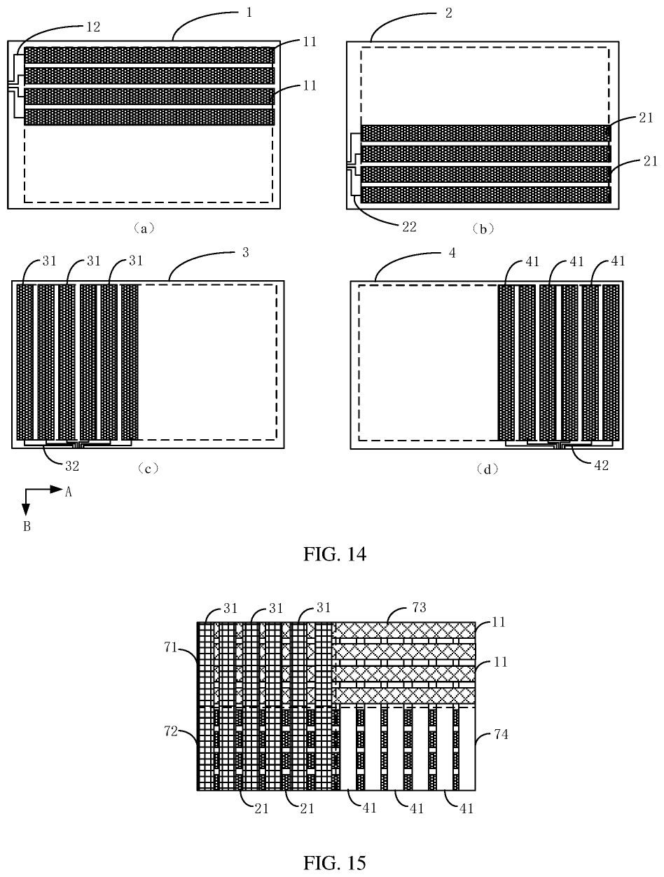

Specifically, as shown in FIG. 14, the second type electrode layer 3 (or 4) includes a first side, a second side, a third side and a fourth side which are adjacent in sequence, the first side is opposite to the third side, and the second side is opposite to the fourth side. The second type touch sensing area includes the plurality of second type electrodes 31 (or 41) extending from the second side to the fourth side (i.e., the second direction B).

The respective two layers of the second type electrode layers which are stacked include the second type peripheral circuit region (i.e., the part between the frame of the second type electrode layer 3 (or 4) and the dashed frame in (c) of FIG. 14 or (d) of FIG. 14) and the second type touch sensing area. The second peripheral circuit region includes the plurality of second signal leads 32 (or 42). The plurality of second signal leads 32 (or 42) converge on the second side or the fourth side of the second peripheral circuit region. The second side or the fourth side of the second peripheral circuit region is provided with a lead concentration portion. The lead concentration portion may be the convergence point of the plurality of the second signal leads on the second side (or the fourth side). First end of the plurality of second signal leads is respectively connected to the plurality of second electrodes, and the second end converges into the lead concentration portion and is connected to the touch chip. The specific distribution of the plurality of second signal leads 32 (or 42) is not specifically limited in the embodiments of the present disclosure and may be flexibly set according to actual situations.

In one example, the outgoing lines of the signal leads of the two layers of the second type electrode layers which are stacked are single-sided concentrated outgoing lines. That is, the signal leads in the two layers of the electrode layers are both located on the second side or the fourth side.

It should be understood that, for the entire touch panel, only outgoing lines on two sides are required. That is, the first type electrode has only two group of the lead concentration portions, such as the plurality of first signal leads in (a) of FIG. 14 and (b) of FIG. 14 are in the convergence area of the first side, and are distributed on the same side. The first type electrode may only route out on the first side or the third side. Similarly, the second type electrode also has two groups of the lead concentration portions, such as the plurality of second signal leads in (c) of FIG. 14 and (d) of FIG. 14 are in the convergence area of the fourth side, and are distributed on the same side. The second type electrode may only route out on the second side or the fourth side.

Therefore, in the embodiments of the present disclosure, the first type electrodes are arranged in at least two layers, resulting in a reduction in the quantity of signal leads corresponding to each layer. Additionally, by adopting a two-sided outgoing line manner for the entire touch panel, as opposed to the single-sided outgoing line manner, it further reduces the edge width of the touch panel.

In the embodiments of the present disclosure, the plurality of second signal leads are distributed on the first side and the fourth side, adjacent to the second type touch sensing area, of the second peripheral circuit region, the first side and the fourth side are both provided with lead concentration portions, and second ends of the plurality of second signal leads are converged into the lead concentration portion.

Specifically, as shown in FIG. 9, the second type electrode layer 3 (or 4) includes a first side, a second side, a third side and a fourth side which are adjacent in sequence, the first side is opposite to the third side, and the second side is opposite to the fourth side. The second type touch sensing area includes the plurality of second type electrodes 31 (or 41) that extend from the second side to the fourth side (i.e., the second direction B).

the two layers of the second type electrode layer which are stacked include a second peripheral circuit region (i.e., the part between the frame of the second type electrode layer 3 (or 4) and the dashed frame in (a) of FIG. 9 or (b) of FIG. 9) and a second type touch sensing area. The second peripheral circuit region includes the plurality of second signal leads 32 (or 42). The plurality of second signal leads 32 (or 42) are converged into the first side or the fourth side, near one side of the second type touch sensing area, of the second peripheral circuit region. The first side (or the third side) and the fourth side of the second peripheral circuit region is provided with a lead concentration portion. The lead concentration portion may be the concentrating place of the plurality of second signal leads at the first side (or the third side) and the fourth side, and first ends of the plurality of second signal leads are electrically connected to the plurality of second type electrodes respectively, and the second ends are converged into the lead concentration portion and connected with the touch chip.

For example, the plurality of second type electrodes 31 (or 41) are divided into two groups based on the symmetry axis parallel to the direction B in the second type touch sensing area, one group of the plurality of second type electrodes 31 converges the plurality of second signal leads 32 connected with them to the second side, and the other group of the plurality of second type electrodes 31 converges the plurality of second signal leads 32 connected with them to the fourth side. For example, the distribution of the leads in (c) of FIG. 9.

Alternatively, one group of the plurality of second type electrodes 41 converges the plurality of second signal leads 42 connected with them to the fourth side, and the other group of the plurality of second type electrodes 41 converges the plurality of second signal leads 42 connected with them to the third side, for example, the distribution of the leads in (d) of FIG. 9. The specific form of the distribution of the leads is not limited in the embodiments of the present disclosure.

It should be understood that for the entire touch panel, this solution requires routing out from four sides. The first type electrodes have four groups of the lead concentration portions, and are distributed on three sides, for example, referring to on the second side, the fourth side+the first side or the third side in (a) of FIG. 9 and (b) of FIG. 9. Similarly, the second type electrode have four groups of the lead concentration portions, and are distributed on three sides, for example, referring to on the first side, the third side+the second side or the fourth side in (c) of FIG. 9 and (d) of FIG. 9.

Therefore, in the embodiments of the present disclosure, the first type electrodes are arranged into at least two layers, so that the quantity of signal leads corresponding to each layer is reduced. Meanwhile, the entire touch panel adopts a three-side outgoing line manner, and compared with the two-sided outgoing line manner, the edge width of the entire touch panel is reduced.

In an embodiment of the present disclosure, the touch panel further includes at least one second optical adhesive layer for adhering the at least two second type electrode layers, and the at least two second type electrode layers are adhered by the at least one second optical adhesive layer.

Specifically, the quantity of the second optical adhesive layers is proportional to the quantity of the second type electrode layers, and the more the quantity of the second type electrode layers, the more the second optical adhesive layers for adhering. For example, when the quantity of the second type electrode layer is two, the quantity of the second optical adhesive layer is one; and when the quantity of the second type electrode layer is three, the quantity of the second optical adhesive layer is two.

It should also be noted that the first optical adhesive layer and the second optical adhesive layer are only for convenience of distinguishing, and may be substantially the same type of the optical adhesive or the same type of the optical adhesive. With regard to the related description of the optical adhesive layer, please refer to the description of the above embodiments for details, which is not be repeated here for avoiding repetition.

Therefore, in the embodiments of the present disclosure, the at least two first type electrode layers are adhered by the optical adhesive, so that the light transmittance of the touch panel is enhanced, thereby reducing the impact of external forces on the touch panel, and improving the impact resistance of the touch panel.

In an embodiment of the present disclosure, the touch panel further includes at least one second substrate for carrying the at least two second type electrode layers, and the at least two second type electrode layers are respectively arranged on different surfaces of the at least one second substrate.

Specifically, the second substrate is equivalent to a carrier board to the two second electrode layers, and the second substrate may be prepared by processes such as yellow light process or sputtering. Forming the plurality of second type electrodes (such as the second type electrode 31 in FIG. 9) on one surface of the second substrate to obtain the second type electrode layer, and forming the plurality of first type electrodes are on the other surface of the second substrate to obtain another second type electrode layer.

Preferably, the material of the second substrate of the embodiments of the present disclosure is made of a PET plastic material.

It should be noted that the first substrate and the second substrate are merely for convenience of distinguishing, and they may be substantially the same type or the same type of the substrate. With regard to the related description of the substrate, please refer to the description of the above embodiments for details, which is not repeated here for avoiding repetition.

It should also be noted that a layer of metal mesh electrode formed based on the first substrate and a layer of metal mesh electrode formed based on the second substrate may be adhered by the optical adhesive layer.

Therefore, the two layers of the second type electrode layers in the embodiments of the present disclosure are used as carriers in the correspondingly arranged substrates, so that the thickness of the touch panel may be reduced, thereby making the touch panel lighter and thinner.

FIG. 15 is a schematic structural diagram of a top view of a touch device according to an embodiment of the present disclosure. As shown in FIG. 15, the touch device includes a touch panel and a signal conditioning chip. The touch panel includes two first type electrode layers respectively forming four mutual capacitance structures with two second type electrode layers. The signal conditioning chip is connected to the touch panel and configured to receive an inductive capacitance value output by the touch panel, and determine a validity of the inductive capacitance value based on set capacitance thresholds corresponding to the respective mutual capacitance structures. It should be noted that the touch panel is basically the same as the touch panel shown in FIG. 9. Please refer to the description in the embodiments of FIG. 9 for details, which is not repeated here for avoiding repetition.

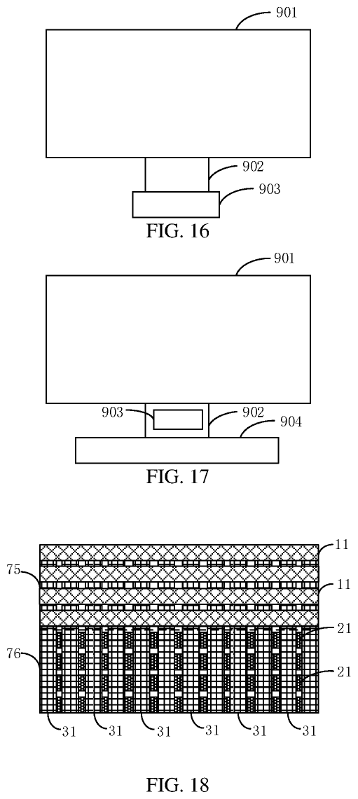

Specifically, the touch device shown in FIG. 16 includes the touch panel 901, a flexible Printed Circuit (FPC) 902, and the signal conditioning chip 903. The signal conditioning chip 903 may be connected to the touch panel 901 through at least one FPC board 902, and the FPC board 902 may include a plurality of metal leads. First end of the plurality of metal leads in the FPC board 902 is connected to the lead concentration portion of the touch panel 901, and the second end is connected to the signal conditioning chip 903 or the touch chip.

It should be noted that the quantity of the FPC board may be the same as the quantity of the lead concentration portion of the touch panel, that is, the FPB boards are in one-to-one correspondence with the lead concentration portions, or one FPC board may be connected to at least one lead concentration portion on one side of the touch panel, that is, the one side of the touch panel corresponds to the one FPC board, which is not specifically limited in the embodiments of the present disclosure.

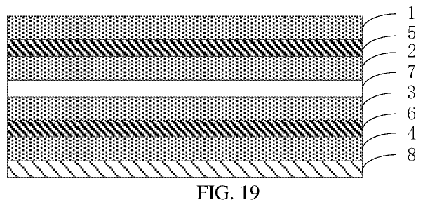

In an example, when the signal conditioning chip is integrated in the FPC, as shown in FIG. 17, first end of the FPC board 902 is connected to the touch panel 901, and the second end is connected to the touch chip 904 of the touch device, and the FPC board 902 includes the signal conditioning chip 903.

With continued reference to FIG. 15, the first type touch sensing area formed by combining a plurality of first type electrodes 11 and the first type touch sensing area formed by combining a plurality of first type electrodes 21 may be spliced and filled in the touch area by their orthographic projections on the touch area. The second type touch sensing area formed by combining a plurality of second type electrodes 31 and the second type touch sensing area formed by combining a plurality of second type electrodes 41 may be spliced and filled the touch area by their orthographic projections on the touch area.

The touch area may be divided into four mutual capacitance structures by layering the four layers of the electrodes. As shown in the orientation of FIG. 15, the four mutual capacitance structures are a first mutual capacitance structure 71, such as the upper-left; a second mutual capacitance structure 72, such as the lower-left; a third mutual capacitance structure 73, such as the upper-right; a fourth mutual capacitance structure 74, such as the lower-right (see the area divided by the dashed lines in FIG. 15).

The at least two set capacitance thresholds are pre-stored in the signal conditioning chip. It should be noted that the quantity of the set capacitance thresholds may be set according to the quantity of the electrode layers (i.e., the first type electrode layer and the second type electrode layer), and the quantity of the set capacitance thresholds is not specifically limited in the embodiments. For example, the quantity of the electrode layers is four, and the quantity of the set capacitance thresholds is four. For another example, the quantity of the electrode layers is three, and the quantity of the set capacitance thresholds is two.

In one embodiment, the set capacitance threshold is related to an electrode spacing between the corresponding mutual capacitance structures, and/or the set capacitance threshold is related to a distance from the corresponding upper layer electrode layer forming the mutual capacitance structure to a surface of the touch device.

In one embodiment, the set capacitance threshold may be a lowest capacitance threshold in the touch area corresponding to respective mutual capacitance structure; and the signal conditioning chip determines the validity of the inductive capacitance value output by the touch panel based on the set capacitance threshold corresponding to the respective mutual capacitance structure.

For example, when the signal conditioning chip receives an inductive capacitance value output by the touch panel, the mutual capacitance structure that generates the inductive capacitance value may be determined according to the first type electrode (such as the driving electrode) and the second type electrode (such as the inductive electrode) that generate the inductive capacitance value., and then the set capacitance threshold corresponding to the mutual capacitance structure is called and compared with the inductive capacitance value. If the inductive capacitance value is greater than the set capacitance threshold, it is determined that the inductive capacitance value is valid, that is, the area, where the inductive capacitance value is generated, is the area touched by a touch object.

In one embodiment, the set capacitance threshold may be a range of capacitance values; The signal conditioning chip determines the validity of the inductive capacitance value output by the touch panel based on the set capacitance threshold corresponding to the respective mutual capacitance structure.

For example, when the signal conditioning chip receives the inductive capacitance value output by the touch panel, the inductive capacitance value is compared with the set capacitance threshold corresponding to the respective mutual capacitance structure, and if the inductive capacitance value falls within a certain set capacitance threshold range, it is determined that the inductive capacitance value is valid, and it is determined that the touch area corresponding to the set capacitance threshold that the inductive capacitance value falls is the area where the touch operation occurs. The touch device may further determine a specific touch coordinates in the touch area according to the driving electrode and the sensing electrode where the inductive capacitance value generated, and if the inductive capacitance value is not fall within any the set capacitance threshold range, it is determined that the inductive capacitance value is invalid, that is, no effective touch operation has occurred.

It should be noted that the set capacitance threshold may also be set in other forms, and the specific form of the set capacitance threshold is not specifically limited in the embodiments of the present disclosure.

Therefore, in embodiments of the present disclosure, one type of the electrode of the touch panel is arranged in different layers, so that the distances from the touch capacitive units to the fingers at different positions in the touch area are not entirely the same, and the spacing between the two electrode layers constituting the capacitive unit is also not entirely the same, so that when the finger touches at the different positions in the touch area, the inductive capacitance value output by the touch panel may not be entirely the same. In addition, in the present disclosure, the set capacitance threshold corresponding to the mutual capacitance structure is pre-stored in the signal conditioning chip, and the inductive capacitance value output by the touch panel is compared with the set capacitance threshold, so as to help identify the touch position and improve the identification degree of a touch signal.

In an embodiment of the present disclosure, the set capacitance threshold is related to the electrode spacing between the corresponding mutual capacitance structures, and/or the set capacitance threshold is related to the distance from the corresponding upper electrode layer forming the mutual capacitance structure to the surface of the touch device.

Specifically, the set capacitance threshold may be determined based on the electrode spacing between the mutual capacitance structures, for example, the greater electrode spacing, the smaller the corresponding set capacitance threshold. The set capacitance threshold may also be determined based on a distance between the upper electrode layer forming the mutual capacitance structure and a surface of the touch device, for example, the smaller the distance, the greater the corresponding set capacitance threshold. The set capacitance threshold may also be determined based on the electrode spacing of the mutual capacitance structure and the di stance from the upper electrode layer to the surface of the touch device at the same time, which is not specifically limited in the embodiments of the present disclosure.

Therefore, in the embodiments of the present disclosure, the set capacitance threshold is determined according to the electrode spacing and the distance from the upper electrode layer to the surface of the touch device, so that the induced signals detected by the mutual capacitance structures in different areas are different, thereby improving the identification degree of a touch signal.

In an embodiment of the present disclosure, the at least two set capacitance thresholds include a first set capacitance threshold, a second set capacitance threshold, a third set capacitance threshold and a fourth set capacitance threshold. The at least two first type electrode layers include a first electrode layer and a second electrode layer, the at least one second type electrode layer includes a third electrode layer and a fourth electrode layer, and the first electrode layer, the third electrode layer, the second electrode layer, and the fourth electrode layer are sequentially stacked. A first mutual capacitance structure composed of the first electrode layer and the third electrode layer corresponds to the first set capacitance threshold; a second mutual capacitance structure composed of the second electrode layer and the third electrode layer corresponds to the second set capacitance threshold; a third mutual capacitance structure composed of the second electrode layer and the fourth electrode layer corresponds to the third set capacitance threshold; and a fourth mutual capacitance structure composed of the first electrode layer and the fourth electrode layer corresponds to the fourth set capacitance threshold.

Specifically, the touch device includes two layers of the first type electrode layers and two layers of the second type electrode layers are sequentially stacked, and one of the two layers of the first electrode layers is the first electrode layer, and the other is the second electrode layer. One of the two layers of the second electrode layers is the third electrode layer and the other is the fourth electrode layer.

In an example, the touch panel in the touch device is sequentially stacked as the first type electrode layer on the first layer (i.e., the first electrode layer), the second type electrode layer on the second layer (i.e., the third electrode layer), the first type electrode layer on the third layer (i.e., the second electrode layer) and the second type electrode layer on the fourth layer (i.e., the fourth electrode layer).

As shown in FIG. 15, the first mutual capacitance structure 71, composed of the first type electrode layer on the first layer and the second type electrode layer on the second layer, corresponds to the first set capacitance threshold; the second mutual capacitance structure 72, composed of the second type electrode layer on the second layer and the first type electrode layer on the third layer, corresponds to the second set capacitance threshold; the third mutual capacitance structure 73, composed of the first type electrode layer on the first layer and the second type electrode layer on the fourth layer, corresponds to the third set capacitance threshold; the fourth mutual capacitance structure 74, composed of the first type electrode layer on the third layer and the second type electrode layer on the fourth layer, corresponds to the fourth set capacitance threshold.

In view of the electrode spacing, three mutual capacitance structures of the first mutual capacitance structure 71, the second mutual capacitance structure 72 and the fourth mutual capacitance structure 74, the upper and lower electrodes constituting the mutual capacitance are adjacent layers, and the electrode spacing of the adjacent layers may be considered to be the same and the minimum spacing. The third mutual capacitance structure 73, consisting of the first type electrode layer on the first layer and the second electrode layer on the fourth layer, has the largest spacing. Therefore, the capacitance change caused by touch in the area is significantly smaller than that of other three areas.

In view of the distance from the upper electrode of the mutual capacitance structure to the surface of the touch device, although the capacitance distances of the three mutual capacitance structures of the first mutual capacitance structure 71, the second mutual capacitance structure 72 and the fourth mutual capacitance structure 74 are the same, but the upper electrode of the first mutual capacitance structure 71 is the first type electrode layer on the first layer, the upper electrode of the second mutual capacitance structure 72 is the second type electrode layer on the second layer, and the upper electrode of the fourth mutual capacitance structure 74 is the first type electrode layer on third layer. Therefore, for the same touch operation, when the first mutual capacitance structure 71 touches, the finger is closest to the mutual capacitance, and the generated capacitance variation should be maximum, and when the fourth mutual capacitance structure 74 touches, the finger is farthest from the mutual capacitance, and the generated capacitance variation should also be minimum.

Therefore, different thresholds may be set for different areas according to a specific stacking mode, so that during the detection, the signal conditioning chip may determine the corresponding areas according to the first type electrode layer and the second type electrode layer in different stacking modes, so as to select an appropriate threshold for determination.

For example, the first set capacitance threshold is greater than the second set capacitance threshold than the fourth set capacitance threshold is greater than the third set capacitance threshold. It should be noted that, the specific value of the set capacitance threshold may be determined according to the actual situation, which is not specifically limited in the embodiments of the present disclosure.

It should also be noted that the stacking sequence of the four layers of the electrode layers may be set according to the actual situation, such as the second type electrode layer on the first layer (i.e., the third electrode layer), the first type electrode layer on the second layer (i.e., the first electrode layer), the second type electrode layer on the third layer (i.e., the fourth electrode layer) and the first type electrode layer on the fourth layer (i.e., the second electrode layer). The specific sequence of the arrangement of the electrode layer is not limited in the embodiments of the present disclosure, and it should be understood that as long as the same type of electrode layer is divided into at least two layers of stacked structures, and different areas correspond to different set capacitance thresholds, it should fall within the scope of the present disclosure.

It should also be noted that if a substrate is arranged between each electrode layer (the first type electrode layer or the second type electrode layer), the corresponding set capacitance threshold should be adjusted accordingly.

Therefore, in the embodiments of the present disclosure, the set capacitance threshold corresponding to the mutual capacitance structure is pre-stored in the signal conditioning chip, so that the mutual capacitance structures with different electrode spacing have different the set capacitance thresholds, and then the signal conditioning chip compares the received inductive capacitance value with the set capacitance threshold, so as to help identify the touch position and improve the identification degree of the induced signal.

In an embodiment of the present disclosure, at least two set capacitance thresholds include a fifth set capacitance threshold and a sixth set capacitance threshold. The at least two first type electrode layers include a fifth electrode layer and a sixth electrode layer. The at least one second type electrode layer includes a seventh electrode layer, and the fifth electrode layer, the seventh electrode layer, and the sixth electrode layer are sequentially stacked. A fifth mutual capacitance structure composed of the fifth electrode layer and the seventh electrode layer corresponds to the fifth set capacitance threshold; and a sixth mutual capacitance structure composed of the seventh electrode layer and the sixth electrode layer corresponds to the sixth set capacitance threshold.

Specifically, the touch panel of the touch device includes two layers of the first type electrode layer and one layer of the second type electrode layer (i.e., the seventh electrode layer), which are stacked. One of the two layers of the first type electrode layers is the fifth electrode layer and the other is the sixth electrode layer.

In an example, the stacking sequence of the electrode layers in the touch panel may sequentially be the first type electrode layer on the first layer (i.e., the fifth electrode layer), the second type electrode layer on the second layer (i.e., the seventh electrode layer) and the first type electrode layer on the third layer (i.e., the sixth electrode layer).

The touch area may be divided into two mutual capacitance structures by layering three layers of the electrode layers. As shown in the orientation of FIG. 18, the two mutual capacitance structures are the fifth mutual capacitance structure 75 for example, an upper portion and the sixth mutual capacitance structure 76 for example, a lower portion (see an area divided by the dashed lines in FIG. 18). In view of the electrode spacing, the fifth mutual capacitance structure 75 and the sixth mutual capacitance structure 76 constitute the mutual capacitance structure, and the upper and lower electrodes thereof are adjacent layers, and the electrode spacing of the adjacent layers may be considered as the same.

In view of the distance from the upper electrode of the mutual capacitance structure to the surface of the touch device, although the capacitance distances of the fifth mutual capacitance structure 75 and the sixth mutual capacitance structure 76 are the same, but the upper electrode of the fifth mutual capacitance structure 75 is the first type electrode layer on the first layer, and the upper electrode of the sixth mutual capacitance structure 76 is the second type electrode layer on the second layer. Therefore, for the same touch operation, when the fifth mutual capacitance structure 75 touches, the finger is closest to the mutual capacitance, and the generated capacitance variation should be the maximum, and when the sixth mutual capacitance structure 76 touches, the finger is farthest from the mutual capacitance, and the generated capacitance variation is also small.

For example, the fifth set capacitance threshold corresponding to the fifth mutual capacitance structure is greater than the sixth set capacitance threshold corresponding to the sixth mutual capacitance structure.

It should be noted that, in the process of setting the capacitance threshold, the capacitance threshold may be set according to the electrode spacing and the distance from the upper electrode of the mutual capacitance structure to the surface of the touch device. That is, the first set capacitance threshold may be the same as the fifth set capacitance threshold. The second set capacitance threshold may be the same as the sixth set capacitance threshold.

It should also be noted that the specific stacked structure of the electrode layers is not limited in the embodiments of the present disclosure, and it may be the second type electrode layer on the first layer, the first type electrode layer on the second layer and the second type electrode layer on the third layer, which are not specifically limited in the embodiments of the present disclosure.

Therefore, in the embodiments of the present disclosure, the set capacitance threshold corresponding to the mutual capacitance structure is pre-stored in the signal conditioning chip, so that the mutual capacitance structures with different the electrode spacing have different the set capacitance thresholds, and then the signal conditioning chip compares the received inductive capacitance value with the set capacitance threshold, so as to help identify the touch position and improve the identification degree of the induced signal.

In an embodiment of the present disclosure, the first peripheral circuit region includes the plurality of first signal leads, first ends of the plurality of first signal leads are electrically connected to the plurality of first type electrodes, the second ends of the plurality of first signal leads are distributed on at least one side of the first peripheral circuit region and are electrically connected with the signal conditioning chip.

Specifically, the first ends of the plurality of first signal leads are electrically connected to the plurality of first type electrodes, the second ends of the plurality of first signal leads are converged into the lead concentration portion on the at least one side of the first peripheral circuit region and are electrically connected with the signal conditioning chip.

In an embodiment of the present disclosure, the plurality of first signal leads are distributed on a first side, adjacent to the first type touch sensing area, of the first peripheral circuit region, and the first side is provided with a lead concentration portion, and the second ends of the plurality of first signal leads are converged into the lead concentration portion and are electrically connected with the signal conditioning chip.

In an embodiment of the present disclosure, the plurality of first signal leads are distributed on the first side and the second side, adjacent to the first type touch sensing area, of the first peripheral circuit region, the first side and the second side are both provided with a lead concentration portion, and the second ends of the plurality of first signal leads are converged into the lead concentration portion, and are electrically connected with the signal conditioning chip.

In an embodiment of the present disclosure, the second peripheral circuit region includes the plurality of second signal leads, first ends of the plurality of second signal leads are electrically connected to the plurality of second type electrodes, the second ends of the plurality of second signal leads are distributed on at least one side of the second peripheral circuit region and are electrically connected with the signal conditioning chip.

Specifically, first ends of the plurality of second signal leads are electrically connected to the plurality of second type electrodes, the second ends of the plurality of second signal leads are concentrated to a lead concentration portion on at least one side of the second peripheral circuit region and are electrically connected with the signal conditioning chip.

In an embodiment of the present disclosure, the plurality of second signal leads are distributed on a fourth side, adjacent to the second type touch sensing area, of the second peripheral circuit region, the fourth side is provided with a lead concentration portion, and the second ends of the plurality of second signal leads are concentrated to the lead concentration portion and are electrically connected with the signal conditioning chip.

In an embodiment of the present disclosure, the plurality of second signal leads are distributed on the first side and the fourth side, adjacent to the second type touch sensing area, of the second peripheral circuit region, the first side and the fourth side are both provided with a lead concentration portion, and the second ends of the plurality of second signal leads are converged into the lead concentration portion, and are electrically connected with the signal conditioning chip.

It should be noted that the distribution mode of the plurality of first signal leads and the plurality of second signal leads in the above embodiments, please refer to the description in the above embodiments for details, which is not repeated here for avoiding repetition.

In an embodiment of the present disclosure, the signal conditioning chip is an independent chip, which is respectively connected to the touch panel and a touch chip of the touch device; or the signal conditioning chip is integrated in a flexible circuit board, and the flexible circuit board is configured to connect the touch panel to the touch chip; or the signal conditioning chip is integrated in the touch chip.

Specifically, the signal conditioning chip may be an independent chip, first end of the signal conditioning chip may be electrically connected to the touch panel through the flexible printed circuit board (such as FIG. 16), and the second end of the signal conditioning chip is electrically connected to the touch chip of the touch device. It should be noted that, in the embodiments, the signal determination of the set capacitance threshold may be completed in the independent chip, and there is no need to improve the touch chip itself, but since the signal conditioning chip is the independent structure, some space may be occupied in terms of hardware than the traditional structure.

The signal conditioning chip may also be integrated into the flexible printed circuit board, that is, first end of the flexible printed circuit board containing the signal conditioning chip is electrically connected to the touch panel, and the second end is electrically connected to the touch chip (such as FIG. 17). The signal conditioning chip may also be integrated into the touch chip, and the form of the signal conditioning chip is not specifically limited in the embodiments of the present disclosure. It should be noted that, in the above two embodiments, both of them are integrated into the existing components, it is necessary to improve the flexible printed circuit board or the touch chip. Therefore, the occupied space of the touch device is basically unchanged since the signal conditioning chip is integrated in the existing components.

Therefore, the embodiments of the present disclosure are not limited to the presentation form of the signal conditioning chip, so that the setting of the signal conditioning chip is more flexible, so as to meet the requirements of different touch devices.

FIG. 19 is a schematic structural diagram of a front view of a touch display device according to yet another embodiment of the present disclosure. As shown in FIG. 19, the touch display device includes two layers of the first type electrode layers, one first type electrode layer 1 and the other first type electrode layer 2. Moreover, the touch display device also includes two layers of the second type electrode layers, one second type electrode layer 3 and the other second type electrode layer 4. In addition, the touch display device also includes two layers of the substrates, that is a first substrate 5 and a second substrate 6. The touch display device also includes an optical adhesive layer 7 and a display screen 8.

Specifically, the front view direction is the direction parallel to the touch display device.

The touch display device includes a first type electrode layer 1, a first substrate 5, another first type electrode layer 2, an optical adhesive layer 7, a second type electrode layer 3, a second substrate 6, another second type electrode layer 4 and a display screen 8 which are sequentially stacked. The arrangement sequence of the two layers of the first type electrode layer and the two layers of the second type electrode layer may be set according to actual requirements, which is not specifically limited in the embodiments of the application.

The display screen 8 may be any one of a Liquid Crystal Display (LCD) display, a Liquid Composite Molding (LCM) display module and an Organic Light-Emitting Diode (OLED) display, which is not specifically limited in the embodiments. The LCD display has the advantages of thin body, saves space, saves electricity, no high temperature and no radiation, which is beneficial to health and is not hurt eyes. The LCM display module has the advantages of size, no radiation, no flicker, low energy consumption and good visual effect. The OLED display screen is a self-luminous display screen, which is not need a backlight screen. It can realize ultra-thin screen, and the OLED has good seismic performance, large viewing angle, short response time, fast refresh speed and flexibility, which is suitable for various working conditions and display shapes.

It should be noted that the embodiments of the present disclosure include the touch panel described in the embodiments of FIGS. 1 to 14.

Therefore, in the embodiments of the present disclosure, one type of the electrode of the touch electrodes is arranged in different layers, the distances between the touch capacitor units and the fingers at different positions in the touch area are not exactly the same, and the distances between the two electrodes constituting the capacitor unit are not exactly the same, so that the induction signal is not exactly the same when the finger touches at the different positions, thereby helping to identity the touch position and improving the identification degree of a touch signal.

Unless otherwise defined, all technical and scientific terms used herein have the same meaning as commonly understood by those skilled in the technical field of this application. The terminology used herein in the specification of this application is only for the purpose of describing specific embodiments, and is not intended to limit this application. As used herein, the term “and/or” includes any and all combinations of one or more related listed items.

Furthermore, the terms “first” and “second” are only used for descriptive purposes, and cannot be understood as indicating or implying relative importance or implicitly indicating the quantity of indicated technical features. Therefore, the features defining “first” and “second” may explicitly or implicitly include at least one such feature.

The above is only the preferred embodiment of this application, and it is not used to limit this application. Any modification and equivalent substitution made within the spirit and principle of this application should be included in the protection scope of this application.

What is claimed is:

1. A touch panel, wherein the touch panel has a touch area, and the touch panel comprises:
at least two first type electrode layers which are stacked, the first type electrode layer having a first type touch sensing area, and respective first type touch sensing areas of the at least two first type electrode layers being spliced and filled in the touch area.

2. The touch panel according to claim 1, wherein the first type touch sensing area comprises a plurality of first type electrodes extending along a first direction; the first type electrode layer comprises a first peripheral circuit region adjacent to the touch area, the first peripheral circuit region comprises a plurality of first signal leads, first ends of which are electrically connected to the plurality of first type electrodes, and the plurality of first signal leads are distributed on at least one side of the first peripheral circuit region.

3. The touch panel according to claim 2, wherein the plurality of first signal leads are distributed on a first side, adjacent to the first type touch sensing area, of the first peripheral circuit region, the first side is provided with a lead concentration portion, and second ends of the plurality of first signal leads are converged into at least one lead concentration portion.

4. The touch panel according to claim 2, wherein the plurality of first signal leads are distributed on a first side and a second side, adjacent to the first type touch sensing area, of the first peripheral circuit region, the first side and the second side are both provided with a lead concentration portion, and second ends of the plurality of first signal leads are converged into the lead concentration portion.

5. The touch panel according to claim 2, wherein the plurality of first type electrodes are metal mesh electrodes which are patterned, and respective first type electrodes of the at least two first type electrode layers are different in polygonal metal mesh patterns.

6. The touch panel according to claim 1, further comprising at least one first optical adhesive layer for adhering the at least two first type electrode layers, wherein the at least two first type electrode layers are adhered by the at least one first optical adhesive layer.

7. The touch panel according to claim 1, further comprising at least one first substrate for carrying the at least two first type electrode layers, wherein the at least two first type electrode layers are respectively arranged on different surfaces of the at least one first substrate.

8. The touch panel according to claim 1, further comprising at least one second type electrode layer, wherein the second type electrode layer comprises a second type touch sensing area, wherein when a quantity of the second type electrode layers is greater than or equal to two layers, the at least one second type electrode layer comprises at least two second type electrode layers which are stacked, and respective second type touch sensing areas of the at least two second type electrode layers are spliced and filled in the touch area.

9. The touch panel according to claim 8, wherein the second type touch sensing area comprises a plurality of second type electrodes extending along a second direction, the plurality of second type electrodes are metal mesh electrodes which are patterned, and respective second type electrodes of the at least two second type electrode layers are different in polygonal metal mesh patterns.

10. The touch panel according to claim 9, wherein the second type electrode layer further comprises a second peripheral circuit region adjacent to the touch area, the second peripheral circuit region comprises a plurality of second signal leads, first ends of which are electrically connected to the plurality of second type electrodes, and the plurality of second signal leads are distributed on at least one side of the second peripheral circuit region.

11. The touch panel according to claim 10, wherein the plurality of second signal leads are distributed on a fourth side, adjacent to the second type touch sensing area, of the second peripheral circuit region, the fourth side is provided with a lead concentration portion, and second ends of the plurality of second signal leads are converged into at least one lead concentration portion.

12. The touch panel according to claim 10, wherein the plurality of second signal leads are distributed on a first side and a fourth side, adjacent to the second type touch sensing area, of the second peripheral circuit region, the first side and the fourth side are both provided with a lead concentration portion, and second ends of the plurality of second signal leads are converged into the lead concentration portion.

13. The touch panel according to claim 8, further comprising at least one second optical adhesive layer for adhering the at least two second type electrode layers, wherein the at least two second type electrode layers are adhered by the at least one second optical adhesive layer.

14. The touch panel according to claim 8, further comprising at least one second substrate for carrying the at least two second type electrode layers, wherein the at least two second type electrode layers are respectively arranged on different surfaces of the at least one second substrate.

15. A touch display device, comprising: a display screen, and the touch panel according to claim 1.

16. A touch device, comprising: the touch panel according to claim 8, wherein at least two first type electrode layers and the at least one second type electrode layer are respectively formed mutual capacitance structures; and
a signal conditioning chip connected to the touch panel and used for receiving an inductive capacitance value output by the touch panel, and determining a validity of the inductive capacitance value based on a set capacitance threshold corresponding to respective mutual capacitance structures.

17. The touch device according to claim 16, wherein the set capacitance threshold is related to an electrode spacing between a corresponding mutual capacitance structures, and/or the set capacitance threshold is related to a distance from a corresponding upper layer electrode layer forming the mutual capacitance structure to a surface of the touch device.

18. The touch device according to claim 16, wherein a quantity of the set capacitance thresholds is 4, the set capacitance thresholds comprise a first set capacitance threshold, a second set capacitance threshold, a third set capacitance threshold and a fourth set capacitance threshold, the at least two first type electrode layers comprise a first electrode layer and a second electrode layer, the at least one second type electrode layer comprises a third electrode layer and a fourth electrode layer, the first electrode layer, the third electrode layer, the second electrode layer, and the fourth electrode layer are sequentially stacked, and a first mutual capacitance structure composed of the first electrode layer and the third electrode layer corresponds to the first set capacitance threshold; a second mutual capacitance structure composed of the second electrode layer and the third electrode layer corresponds to the second set capacitance threshold; a third mutual capacitance structure composed of the second electrode layer and the fourth electrode layer corresponds to the third set capacitance threshold; a fourth mutual capacitance structure composed of the first electrode layer and the fourth electrode layer corresponds to the fourth set capacitance threshold.

19. The touch device according to claim 16, wherein a quantity of the set capacitance thresholds is 2, the set capacitance thresholds comprise a fifth set capacitance threshold and a sixth set capacitance threshold, the at least two first type electrode layers comprise a fifth electrode layer and a sixth electrode layer, the at least one second type electrode layer comprises a seventh electrode layer, the fifth electrode layer, the seventh electrode layer, and the sixth electrode layer are sequentially stacked, and a fifth mutual capacitance structure composed of the fifth electrode layer and the seventh electrode layer corresponds to the fifth set capacitance threshold; a sixth mutual capacitance structure composed of the seventh electrode layer and the sixth electrode layer corresponds to the sixth set capacitance threshold.

20. The touch device according to claim 16, wherein the signal conditioning chip is an independent chip, which is respectively connected to the touch panel and a touch chip of the touch device; or the signal conditioning chip is integrated in a flexible circuit board, and the flexible circuit board is configured to connect the touch panel and the touch chip; or the signal conditioning chip is integrated in the touch chip.
